(19) United States
(12) Patent Application Publication
(10) Pub. No.: US 2015/0241961 A1
(43) Pub. Date: Aug. 27, 2015

(54) ADJUSTING A DISPLAY BASED ON A DETECTED ORIENTATION

(71) Applicants: Paul Morris, Ann Arbor, MI (US); Michael D. Tschirhart, Ann Arbor, MI (US)

(72) Inventors: Paul Morris, Ann Arbor, MI (US); Michael D. Tschirhart, Ann Arbor, MI (US)

(21) Appl. No.: 14/191,015

(22) Filed: Feb. 26, 2014

(51) Int. Cl. G06F 3/01; G09G 5/00; G06F 3/14

(52) U.S. Cl. CPC G06F 3/012; G06F 3/013; G06F 3/1423; G09G 5/003; G09G 2354/00; G09G 2380/10; G09G 2360/04

(57) ABSTRACT

A system and method for adjusting a display based on a detected orientation is disclosed herein. The system includes an orientation detector to detect an orientation of a viewer associated with the display, the display including at least a first display and a second display; an information input module to receive information to output on either the first display or the second display; and a display selector to select either the first display or the second display to output the information based on the detected orientation.

### BACKGROUND

An operator of an electronic system may engage with a visual presentation system to interact with the electronic system. The visual presentation system may include various cues, such as graphical user interface (GUI) elements alerting the operator of a status of the electronic system. The GUI elements may be text or any sort of indication of information. The operator may interact with the visual presentation system in situations where a touch capable device is provided.

In certain cases, an electronic system may be equipped with multiple visual presentation systems. Accordingly, the multiple visual presentation systems may be associated with different locations or displays capable of presenting information.

For example, if the operator is situated in a vehicle (i.e. a driver or passenger of the vehicle), the operator may have multiple visual presentation systems to engage with. For example, the vehicle may have a visual presentation system embedded in a cockpit of a dashboard, embedded in a heads-up display (HUD), or have indicia provided via mirrors or other translucent surfaces. Thus, the visual presentation system may indicate information in various locations.

Recently, human interface techniques known as gaze tracking or head tracking have been implemented. The gaze and head tracking allow an electronic system to detect the location of the operator. The gaze and head tracking monitor the operators head or eyes via an image or video capturing device, and accordingly, translate the movement and location into commands to control the electronic system. Essentially, the head and the eyes become pointing devices employed to operate various controls and commands. As interfaces become more sophisticated, this allows an operator to engage an electronic system or visual presentation system independently of one's hand. In certain situations, for example driving a vehicle, because the operator's hand stays on a steering wheel, the operator may experience a safer and more convenient driving environment.

### SUMMARY

A system and method for adjusting a display based on a detected orientation is disclosed herein. The system includes an orientation detector to detect an orientation of a viewer associated with the display, the display including at least a first display and a second display; an information input module to receive information to output on either the first display or the second display; and a display selector to select either the first display or the second display to output the information based on the detected orientation.

### DESCRIPTION OF THE DRAWINGS

The detailed description refers to the following drawings, in which like numerals refer to like items, and in which:

FIG. 1 is a block diagram illustrating an example computer.

FIG. 2 is an example of a system for adjusting a display based on a detected orientation.

FIG. 3 is an example of a method for adjusting a display based on a detected orientation.

FIGS. 4A-4C are examples of implementation of the system of FIG. 2 and the method of FIG. 3.

FIGS. 5A and 5B illustrate another example implementation of the system of FIG. 2 and method of FIG. 3.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Providing information to an operator of an electronic system allows the operator to engage in the electronic system in a more robust and dynamic way. Based on the information presented, for example text or graphical, the operator may make guided decisions on how to engage with the electronic system, or the environment in general.

For example, if the electronic system is embedded or incorporated with a vehicle, visual information may convey information associated with the electronic system to a driver or passenger. Accordingly, the driver or passenger may modify the operation of the vehicle based on the indication provided by the display.

The vehicle display may provide safety information, or guidance information. Thus, the vehicle display may alert the vehicle's operator of a hazardous road condition, an instruction to proceed, or certain other information associated with the vehicular operation.

In certain cases, there may be multiple displays installed in a location. For example, relying on the vehicular context, the following locations may be implemented for a display: a heads-up display (HUD), a cockpit display, displays located or integrated with various mirrors and electronics associated with the vehicle.

In these situations, a vehicle operator's head and/or eye gaze direction may be oriented in a first direction at a first display, and information may be displayed on a second display, in a direction in which the vehicle's operator is not oriented. Accordingly, the vehicle's operator may miss the information associated with the second display due to gazing in a different direction.

Disclosed herein are systems and methods for adjusting a display based on a detected orientation. According to the aspects disclosed herein, in situations where multiple displays are implemented along with an electronic system, information may be adjusted accordingly. Thus, the operator associated with the electronic system may be alerted to critical or important information. Even in situations where the information is not critical, an implementer of the systems disclosed herein may assign a priority associated with information, and accordingly, the information with the highest priority may be displayed to a vehicle's operator.

The aspects disclosed herein employ either gaze tracking or head tracking to determine an orientation of an operator's attention. Accordingly, the gaze tracking and head tracking determine which direction the operator's attention is directed to, and adjusts the displays so that the information with a higher priority is directed towards the display being gazed at.

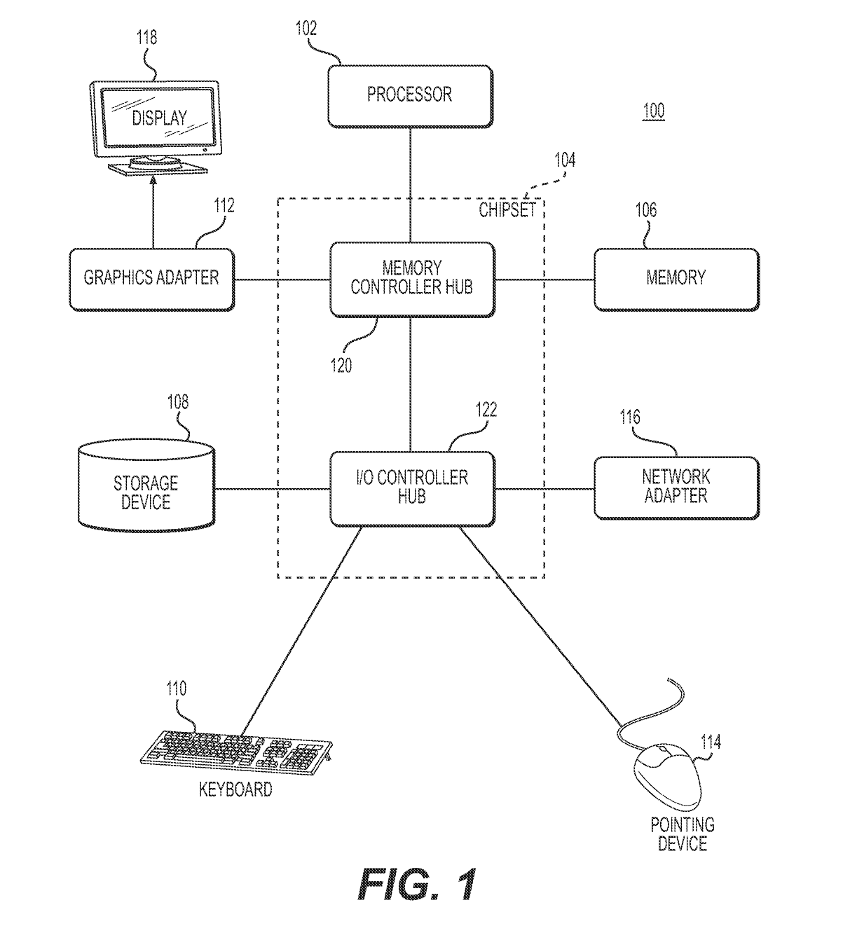

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM). DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server.

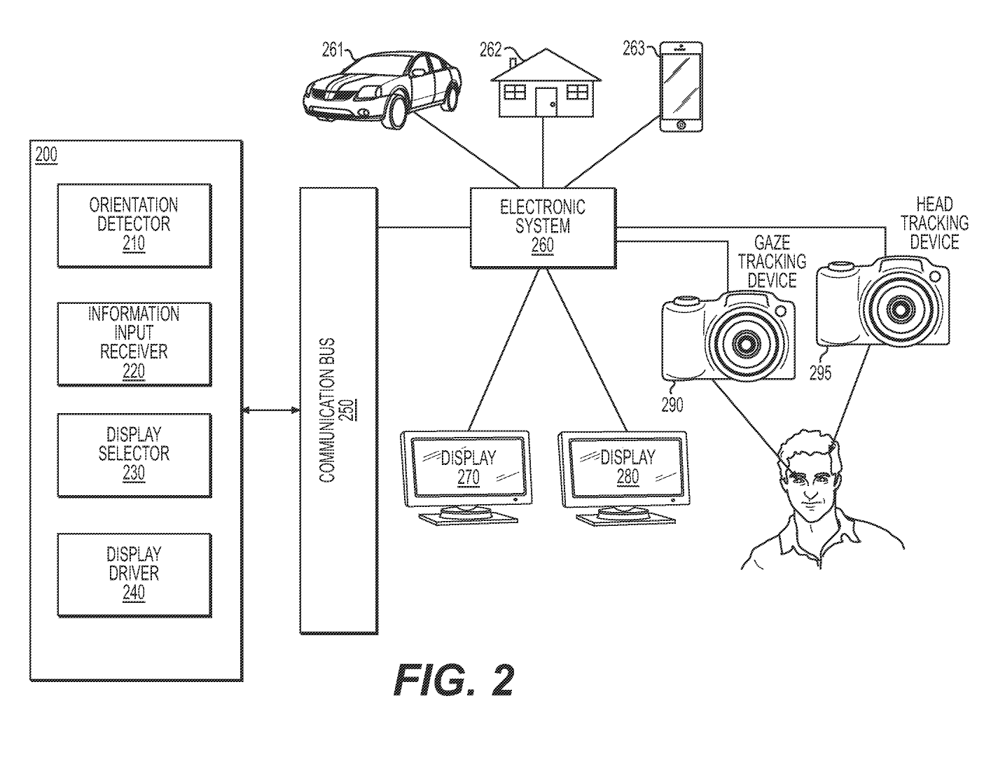

FIG. 2 is an example of a system 200 for adjusting a display based on a detected orientation. The system 200 includes an orientation detector 210, an information input receiver 220, a display selector 230, and a display driver 240. The system 200 communicates to various other electronic systems via a communication bus 250. The communication bus 250 may be a wired or wireless communication medium that allows bi-directional signal propagation. Accordingly, various aspects of the system 200, and the devices associated with system 200 may be controlled by the signals communicated to and from the communication bus 250. The system 200 may be implemented via a computer 100.

Referring to FIG. 2, the system 200 may be coupled to an electronic system 260. As explained above, the electronic system 260 may be associated with a variety of systems, such as a vehicular operation 261, a home 262, or a consumer electronic device 263. In addition to the electronic system 260, various displays may be included as well. The displays, such as display 270 and 280, may be situated at various portions of a user environment. Two displays are shown; however, an implementer of system 200 may implement the electronic systems with more or less number of displays dependent on an implementation preference.

Also shown in FIG. 2, is a gaze tracking device 290 and a head tracking device 295. An implementation of system 200 may be incorporated with either a gaze tracking device 290 or a head tracking device 295, or both. The gaze tracking device 290 and the head tracking device 295 may serve to determine an orientation or direction associated with electronic system 260's operator. Alternatively, the system 200 may be implemented along with any sort of technique employed to determine the operator's direction or attention.

As shown in FIG. 2, the gaze tracking device 290 and head tracking device 295 are shown as separate and distinct devices. However, the gaze tracking device 290 and head tracking device 295 may be integrated in one unit, and thus, share a common image/video capturing device.

The gaze tracking device 290 captures an image/video associated with the electronic system 260's operator, and processes the image/video to ascertain the operator's eyes. Based on the image/video of the eyes, the gaze tracking device 290 may ascertain a direction associated with the eye's attention.

The head tracking device 295 works similarly to the gaze tracking device 290, but employs an image/video of the operator's head. Based on the angle of the head detected, a direction of attention of the operator may be obtained.

The orientation detector 210 receives an indication from the either the gaze tracking device 290 or the head tracking device 295 on the direction or orientation of the electronic system 260's operator. The orientation detector 210 may be configured to receive information associated with the electronic system 260's operator at a predefined interval. Accordingly, when the electronic system 260's operator moves their head from side-to-side or to various locations, the orientation detector 210 may ascertain which direction the operator is oriented towards.

In another example, the orientation detector 210 may determine the distance away from the display being oriented at. For example, in real-time or at predetermined intervals, the orientation detector 210 may track the physical distance a viewer is from the display.

The information input module 220 obtains information from the electronic system 260 to display on one of the displays, such as display 270 or display 280. The information input module 220 may cross-reference a persistent store, and employ a lookup table to ascertain whether the information to be displayed is of a priority high enough to display according to the aspects disclosed herein. The lookup table 206 may record whether certain information is to be displayed at a higher priority than other information. The priority associated with each information type may be predefined by an implementer of system 200.

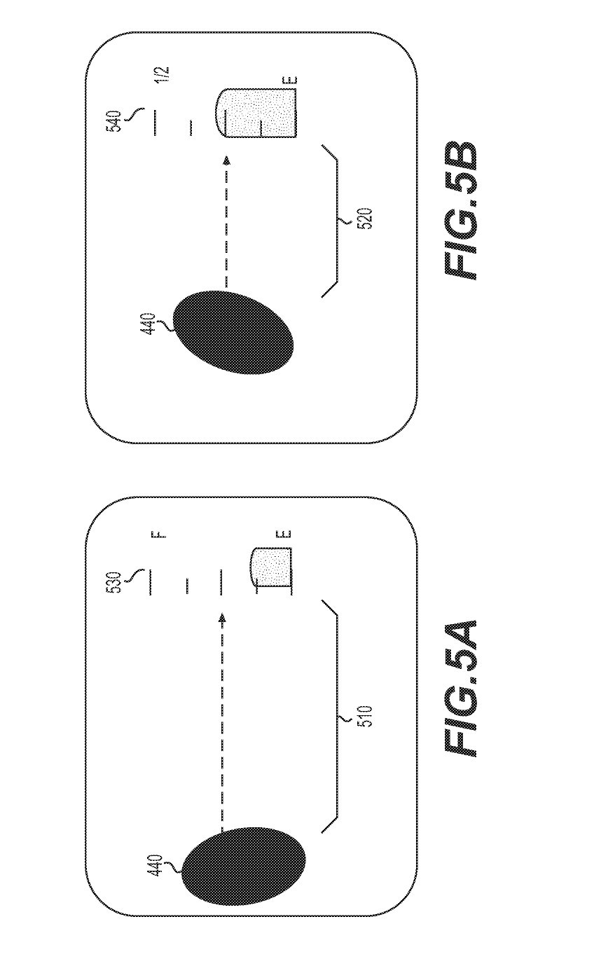

The information may also be augmented with information associated with modifications based on distance. Accordingly, different renderings or amount of information may be presented to a viewer based on the distance from the display. An example of an implementation of system 200 with regards to this example is shown below in FIGS. 5(a) and 5(b).

The display selector 230 correlates the nearest available display to the operator's attention (based on the orientation detector 210), and records the display associated with the operator's attention. Accordingly, if the operator is oriented at or near a certain display, the display selector 230 may record that display as the selected display. As the orientation detector 210 is updated at predetermined intervals, the nearest display in which an operator's attention is directed at may be updated accordingly. Referring to FIG. 2, for example, the display selector 230 may select either display 270 or display 280.

Additionally, or alternatively to, the display selector 230 may operate with a specific portion of a singular display (such as top portion or a bottom portion of display 270, for example). Accordingly, the display selector 230 may select a portion of a single display, instead of one of a multiple array of displays based on the detected orientation.

The display driver 240 determines whether the information being rendered is to be displayed via the selected display (for example, display 270 or display 280). The display driver 240 may select all, some, or none of the information on the selected display.

In another implementation of system 200, the display driver 240 may render a different amount of information based on the detected distance from the display being oriented at. For example, if the viewer of the display 270 moves closer or farther away, an image may be rendered according to the change in distance. In this implementation of system 200, a singular display may be implemented, and the display selector 230 may be omitted. In another example, this implementation may be combined with the example described above.

The information to be displayed according to the aspects disclosed herein may be predefined with a priority. Accordingly, information over a predetermined threshold may be communicated to a selected display accordingly.

For example, according to the aspects disclosed herein, if the system 200 is implemented in a vehicle, certain information may be deemed important enough to be transmitted to a display in which the driver is gazing or oriented at. Safety information item, such as a detected foreign object to the vehicle, may be deemed important, and thus, transmitted to be displayed in a selected display. Conversely, information not deemed important enough (for example, the current radio station), may not be transmitted to the selected display.

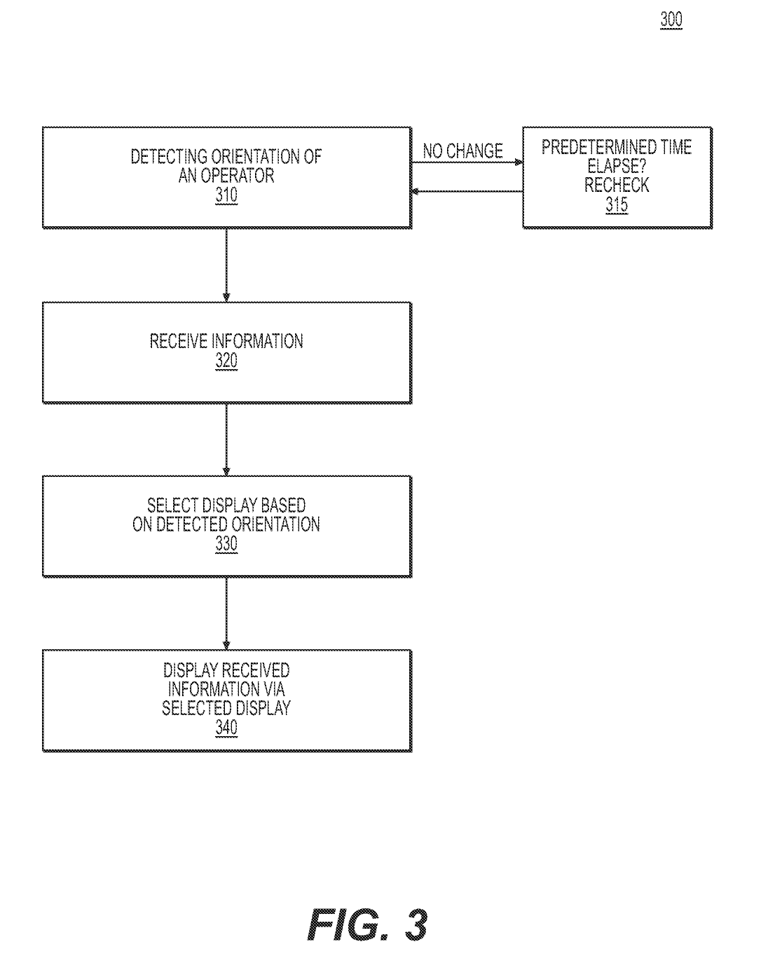

FIG. 3 is an example method 300 for adjusting a display based on a detected orientation. Method 300 may be implemented on a device or system, such as system 200.

In operation 310, a detected orientation of an operator associated with an implementation of method 300 is made. As explained above, the detected orientation may be accomplished via numerous techniques, such as through gaze tracking or head tracking. Further, the detected orientation may determine how far the viewer of the display is from a viewing surface.

In operation 315, if no change in detected orientation is made, a predetermined time interval may be set as to iteratively perform operation 310. Operation 315 is electively added to operation 310, and may occur in parallel with the operations disclosed herein.

In operation 320, information to be transmitted onto one of the displays associated with method 300 is received. The information may include a priority or other augmented information to ascertain the informations criticality or priority of display. For example, if method 300 is implemented in a vehicle, information pertaining to safety and guidance may be set at a higher priority, versus information pertaining to an entertainment system.

In operation 330, a display is selected at which an operator associated with method 300 is directing attention towards. This selection may be performed with the information ascertained in operation 310.

In operation 340, the information received in operation 320 is analyzed to determine if the priority is above a predetermined threshold, and thus, displayed via the selected display in operation 330.

In another implementation, the information may be rendered differently based on the detected distance from a viewing surface. For example, if the viewer is closer to the viewing surface, a larger range of information may be displayed.

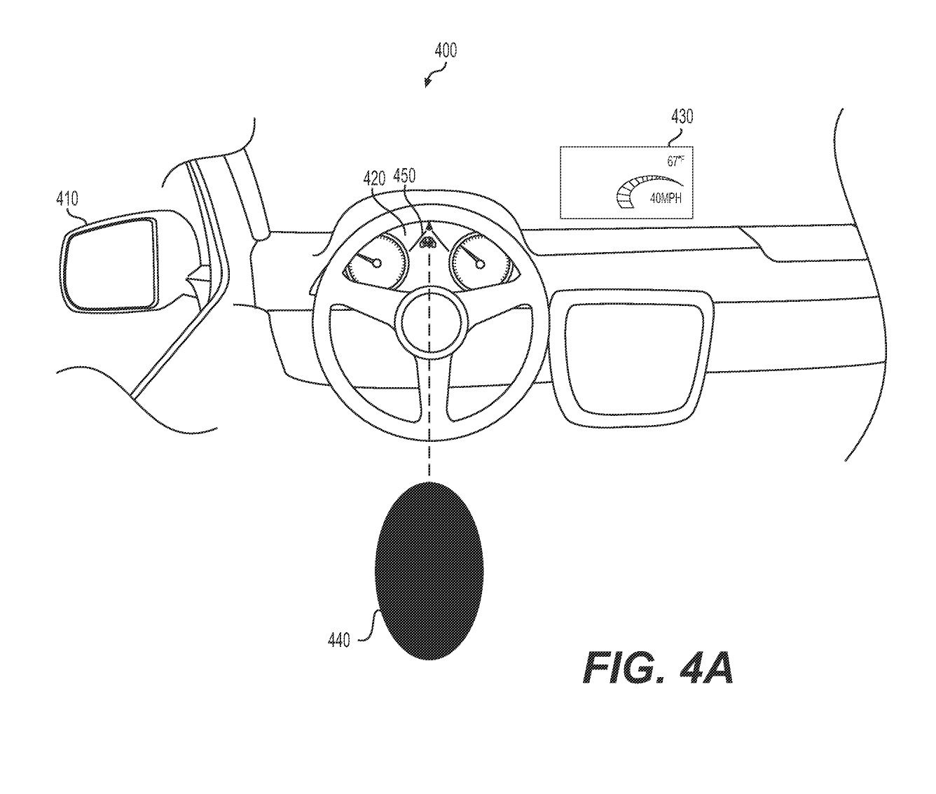

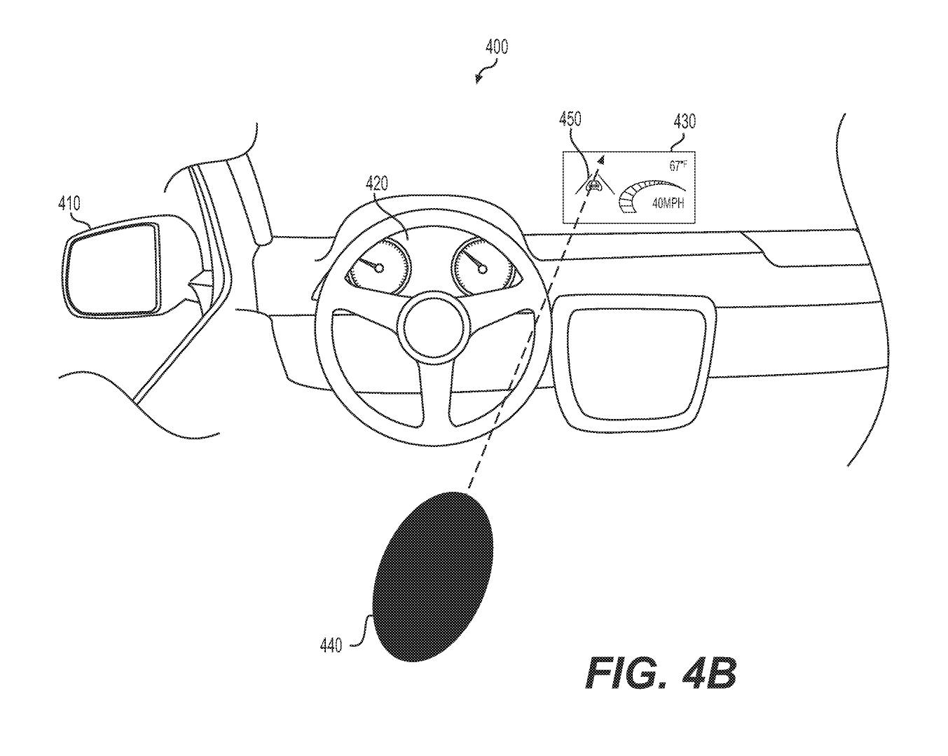

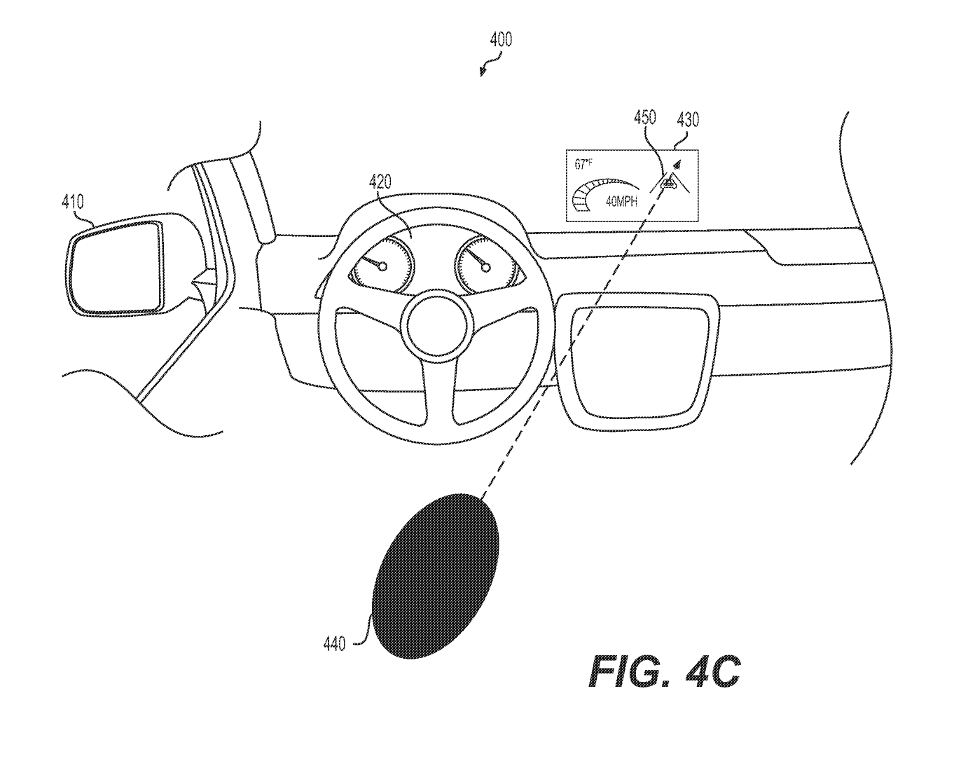

FIGS. 4(a)-(c) illustrate an example implementation of system 200 and method 300. In FIGS. 4(a)-(c), the system 200 and method 300 is implemented in a vehicle 400. The context of a vehicle is merely exemplary; with one of ordinary skill in the art implementing the aspects disclosed herein in numerous systems in which multiple displays and an orientation detector is implemented.

The various displays in FIGS. 4(a)-(c) display information 450, which is an indication that the vehicle is approaching a foreign object. The information 450 depicted below is merely exemplary, with an implementer of system 200 selectively predetermining categories or types of information to undergo the adjustment according the aspects disclosed herein.

As shown in FIG. 4(a), the vehicle 400 has multiple displays, including, but not limited to, a driver-side mirror 410, a cockpit 420, and a heads-up display (HUD) 430. The various displays may be connected to a similar display driver bus coupled to system 200. In 4(a), driver 440 is presently gazing at cockpit 420. Accordingly, information 450 is display via cockpit 420. The system 200 employs an image capturing device to capture the orientation of driver's 440 attention. The image capturing device may be situated anywhere in the vehicle, and thus, be capable of capturing the driver's 440 eyes or head. Accordingly, the image capturing device may be coupled to a gaze tracking device 290 or head tracking device 295, or both.

As shown in FIG. 4(b), the driver 440 is now gazing at the HUD 430. Accordingly, employing the aspects disclosed herein, the information 450 is displayed via the HUD 430.

In FIG. 4(c), the driver 440 is still oriented towards the HUD 430. However, the driver 440 is oriented at another portion of the HUD 430 (different from that shown in FIG. 4(b)). Employing the aspects disclosed herein, the information 450 is displayed in the portion of the HUD display that the driver 440 is oriented at.

FIGS. 5(a) and (b) illustrate an example implementation of system 200 and method 300. In FIGS. 5(a) and (b), the system 200 and method 300 may be implemented in a vehicle 400.

In FIG. 5(a), the operator 440 is viewing a first state of a fuel gauge 530. The first state 530 is rendered based on a detected distance 510 of the operator 440 from the fuel gauge 530. For example, an orientation detector 210 may ascertain from the angle of the gaze or the tilt of an operator's 440 head the distance 510. The first state 530 may be rendered accordingly with a predetermined GUI element to provide the set amount of data based on the distance 510 detected.

In FIG. 5(b), the operator 440 is now a second distance 520 away from the display. Accordingly, employing the aspects disclosed herein, a second state of the fuel gauge 540 is now displayed. As shown, the second state 540 shows information at a greater granularity than in the first state 530. The implementer of system 200 may set the granularity based on predetermined distances away from a display.

Thus, based on the aspects disclosed herein, employing an orientation detection technique, operators of multiple-display systems is provided a robust technique to interact with a system. Accordingly, a safer and more efficient way of engaging with a system may be realized.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for adjusting a display based on a detected orientation, comprising:
a data store comprising a computer readable medium storing a program of instructions for the adjusting of the display;
a processor that executes the program of instructions;
an orientation detector to detect an orientation of a viewer associated with the display, the display including at least a first display and a second display;
an information input module to receive information to output on either the first display or the second display; and
a display selector to select either the first display or the second display to output the information based on the detected orientation.

2. The system according to claim 1, further comprising a display driver to transmit the information to the selected one of the first display or the second display.

3. The system according to claim 2, wherein the display driver selects whether to transmit the information to the selected one of the first display or the second display based on augmented priority data associated with the information.

4. The system according to claim 3, wherein the display driver selects whether to transmit the information to the selected one of the first display or the second display based on the augmented priority data exceeding a predetermined threshold.

5. The system according to claim 1, wherein the orientation detector is a gaze tracking device.

6. The system according to claim 1, wherein the orientation detector is a head tracking device.

7. The system according to claim 1, further comprising a third display to select via the display selector.

8. The system according to claim 1, wherein the first display and the second display are associated with a vehicle.

9. A method implemented via a processor for adjusting a display based on a detected orientation, comprising:
detecting an orientation of a viewer associated with the display, the display including at least a first display and a second display;
receiving information to output on either the first display or the second display; and
selecting either the first display or the second display to output the information based on the detected orientation,
wherein one of the detecting, receiving, or selecting is performed via the processor.

10. The method according to claim 9, further comprising transmitting the information to the selected one of the first display or the second display.

11. The method according to claim 10, wherein the transmitting further comprises selecting whether to transmit the information to the selected one of the first display or the second display based on augmented priority data associated with the information.

12. The method according to claim 11, wherein the transmitting further comprises selecting whether to transmit the information to the selected one of the first display or the second display based on the augmented priority data exceeding a predetermined threshold.

13. The method according to claim 9, wherein the detecting is performed by a gaze tracking device.

14. The method according to claim 9, wherein the detecting is performed by a head tracking device.

15. The method according to claim 9, wherein the selecting further comprises a third display.

16. The method according to claim 9, wherein the first display and the second display are associated with a vehicle.

17. A system for adjusting a display based on a detected orientation, comprising:
a data store comprising a computer readable medium storing a program of instructions for the adjusting of the display;
a processor that executes the program of instructions;
an orientation detector to detect a distance of a viewer associated with the display;
an information input module to receive information to output on the display; and
a display driver to render information based on the detected distance.

18. The system according to claim 17, wherein the orientation detector is a gaze tracking device.

19. The system according to claim 17, wherein the orientation detector is a head tracking device.

20. The system according to claim 17, wherein is associated with a vehicle.
